(19) United States
(12) Patent Application Publication
(10) Pub. No.: US 2020/0400276 A1
(43) Pub. Date: Dec. 24, 2020

(54) CONDUIT IDENTIFYING METHOD AND APPARATUS

(71) Applicant: FICOMMS LIMITED, Auckland (NZ)

(72) Inventors: Paul David HARRIS, Lower Hutt (NZ); Evan Ryan HIRST, Lower Hutt (NZ); Russell John PETHERICK, Lower Hutt (NZ); Sean RAINTHORPE, Auckland (NZ); Oliver Bendix THOMPSON, Lower Hutt (NZ)

(73) Assignee: FICOMMS LIMITED, Auckland (NZ)

(21) Appl. No.: 16/968,481

(22) PCT Filed: Feb. 8, 2018
(86) PCT No.: PCT/IB2018/050767

§ 371 Date: Aug. 7, 2020

(30) Foreign Application Priority Data
Feb. 16, 2017 (NZ) 729170
Jun. 9, 2017 (NZ) 732708

(51) Int. Cl. F17D 5/06; G01M 11/08; G02B 6/44

(52) U.S. Cl. CPC F17D 5/06; G02B 6/502; G02B 6/447; G01M 11/081

(57) ABSTRACT

An apparatus or system for identifying a conduit, having a flexible wall, and comprising at least one open end. The apparatus or system has a gas pressure signal generator for applying a pressure signal at the open end of the conduit to be identified to cause the conduit to be subjected to an increase in internal gas pressure. At least one sensor is provided for measuring, at a measuring location remote from the open end, at least one of the following variables a) width of the conduit, b) diameter of the conduit, c) temperature of the conduit wall, d) load on the conduit wall, and e) strain on the conduit wall. The conduit is identified when the sensor(s) detect(s) a change or changes in the variable(s) experienced by the conduit so identified in response to the gas pressure signal.

### FIELD OF THE INVENTION

The present invention relates to methods and apparatus for identifying a conduit and in particular but not solely for identifying a conduit from a plurality of similar conduits.

### BACKGROUND TO THE INVENTION

Conduits used to house fiber optic cables, telephone cables, network cables, electrical conductors, etc., are generally concealed underground or within building structures once installed. Because of limited access and limited visibility of these conduits, it is typically difficult to identify a particular conduit once installed.

One particular example relates to Fiber to the x (FTTX) installations, for connecting the final part of a fiber cable network between a distribution point and an end point, e.g., a house or group of premises.

One FTTX deployment option involves the installation of microduct systems. Empty networks of ducts (e.g., microducts within one or more sheathed bundles or conduits) are installed underground, e.g., along the length of a street, in preparation for subsequent fiber connection. Because the actual fiber deployment can be deferred (e.g., until the customer requirement has been confirmed), the microduct system provides a flexible FTTX installation option, allowing costs to be deferred.

Prior to the subsequent fiber connection, trenches or holes are dug to access the previously buried microduct bundles or conduits. A section of the outer sheath is cut or removed to expose the microduct bundle, and the appropriate microduct is identified, cut and joined to another branch section of microduct from/to the intended destination. Fiber optic cables may subsequently be deployed into the connected microduct by known techniques such as blowing, pushing or pulling, without the need to splice the fiber.

The installer manually reaches into the hole to identify the correct microduct, and then to perform any subsequent processing of the microduct, in many cases, by first physically entering the hole. This is made possible by having a hole of a sufficiently large size. The typical hole is at least 1 m deep and approximately 1 m wide and 1 m long.

Microducts are typically labelled according to colour, so the installer conventionally selects the correct microduct by visual inspection. This can be difficult to do in the dark conditions of the trench or in inclement weather. Further, the manual inspection process can be slow and prone to error.

Additionally, it will be appreciated that this construction or civil work, i.e., digging the holes to access the microduct conduits, connecting the microducts, and refilling the holes, is an expensive part of the FTTX project. Further, the civil work can cause major and prolonged disruption to traffic, residents and the general public. Reducing the size of the civil work and the cost and time involved therefore offers a substantial scope for reducing the overall cost and disruption caused by the project, and speeding up FTTX deployment. For example, reducing the size of the hole would be a significant contribution to lower costs.

It is an object of the present invention to provide methods and apparatus for identifying a conduit, preferably from a plurality of similar conduits, without relying on visual distinction (either direct visual contact by the user, or by an aided optical or electronic means) of the conduits, to therefore allow for example the identification of a conduit or conduits which are substantially concealed or less visible to the installer, and/or for identification a particular conduit from a group of substantially identical conduits.

It is a further object of the present invention to provide methods and apparatus for identifying a conduit, preferably from a plurality of similar conduits, that go some way to addressing one or more of the disadvantages above, or at least to provide the public with a useful choice.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY OF THE INVENTION

In one aspect, the present invention broadly consists in an apparatus or system for identifying a conduit (that is preferably to be selected from a plurality of conduits), said or each said conduit having a flexible wall, and said conduit to be identified comprising at least one open end, the apparatus or system comprising:
a gas pressure signal generator for applying a pressure signal at said open end of said conduit to be selected, to cause said conduit to be subjected to an increase in internal gas pressure,
at least one sensor for measuring, at a measuring location remote from said open end, at least one of the following variables:

a) width of the conduit,

b) diameter of the conduit,

c) temperature of the conduit wall,

d) load on the conduit wall, and

e) strain on the conduit wall,
wherein said conduit is identified when said sensor(s) detect(s) a change or changes in said variable(s) experienced by said conduit so identified in response to said gas pressure signal.

In one embodiment, the at least one sensor is able to be sequentially moved to individual conduits for measuring said variable(s).

In another embodiment, the at least one sensor is actuable to be sequentially moved to individual conduits for measuring said variable(s).

In another embodiment, an actuator is provided to sequentially move said sensor(s) to individual conduits for measuring said variable(s).

In another embodiment, the apparatus further comprises a controller for automated control of said sensor(s) and/or said actuator, wherein said controller is configured to cause a signal to be generated once said conduit has been selected.

In another embodiment, the apparatus further comprises a controller for automated control of said sensor(s) and/or said actuator, wherein said controller is configured to stop movement of said sensor to another conduit once said conduit has been identified.

In another embodiment, said sensor is positioned on or adjacent a conduit when measuring said variable(s).

In another embodiment, said gas pressure signal generator comprises or generates a source of compressed gas.

In another embodiment, said gas pressure signal generator further comprises:
a signal generator, and
an outlet valve controlled by said signal generator,
wherein said gas pressure signal generator is configured to output pressure signals comprising low frequency changes in gas pressure.

In another embodiment, said gas pressure changes at a frequency of between 0.05 Hz to 5 Hz.

In another embodiment, the gas pressure changes at a frequency of approximately 0.1 Hz.

In another embodiment, said actuator retains said sensor(s) at a said conduit for measuring said one or more variables for a duration of between 1 second and 60 seconds.

In another embodiment, said sensor(s) is/are retained at a said conduit for a duration of approximately 20 seconds.

In another embodiment, each conduit comprises a sealed end.

In another embodiment, each conduit to be measured is sealed or caused to be sealed at a location such that said sensor measures said conduit intermediate of the open end and where the conduit is sealed.

In another embodiment, said conduits are substantially hollow at the measuring location.

In another embodiment, said conduits are empty save for containing a fluid at the measuring locations.

In another embodiment, one or more of said plurality of conduits is partially filled with water.

In another embodiment, a maximum amplitude of said pressure signal is between 200 and 1500 kPa.

In another embodiment, the at least one sensor comprises one or more of:

a) a linear variable differential transformer,

b) an optical displacement sensor,

c) an optical micrometer,

d) an ultrasonic displacement sensor,

e) a capacitive displacement sensor,

for measuring radius and/or diameter of the conduit wall.

In another embodiment, the at least one sensor comprises one or more of:

a) a load cell,

b) a piezoelectric force sensor,

for measuring load on the conduit wall.

In another embodiment, the at least one sensor comprises at least one strain gauge for measuring strain on the conduit wall.

Preferably, the strain gauge is mounted to a jaw able to be slipped over a conduit, the jaw applying a diametrically opposed force to said conduit yet able to displace against the force, the displacement being measured by the strain gauge.

In another embodiment, the apparatus further comprises a compressor to compress said conduit at or adjacent the measurement location to deform said conduit under a preload.

In another embodiment, said compressor radially compresses said conduit with a preload of at least about 3 kg.

In another embodiment, when said gas pressure signal is applied to a said conduit that is under compression, said compressor can yield to allow the conduit to move back towards its un-deformed shape.

In another embodiment, said sensor measures the displacement of said conduit wall as said conduit moves back towards its un-deformed shape.

In another embodiment, said sensor is positioned to measure the displacement of said conduit wall as said conduit moves back towards its un-deformed shape.

In another embodiment, the at least one sensor and the compressor are mounted to a common structure.

In another embodiment, the compressor is able to be sequentially moved to individual conduits for compressing each said conduit.

In another embodiment, the compressor and the at least one sensor are able to be moved in unison.

In another embodiment, the compressor and the at least one sensor are adapted to engage with a common conduit during compression and measuring.

In another embodiment, a compressor is provided that is actuable to apply a radially compressive force to each conduit to deform the conduit, the compressor being able to yield as the conduit moves back towards its un-deformed shape upon the application of gas pressure, the at least one sensor measuring the yield of the compressor to thereby identify the conduit.

In another embodiment, the at least one sensor comprises one or more of:

a) a thermocouple,

b) a thermal imaging camera,

c) an infrared sensor,

for measuring temperature of the conduit wall.

In another embodiment, said plurality of similar conduits are microducts located within an in-ground hole.

In another embodiment, after said conduit is identified, a fiber optic cable is pushed, pulled or blown into said identified conduit.

In another embodiment, each said microduct has an inner diameter of between 3.5 mm and 10 mm, and an outer diameter of between 5 and 14 mm.

In another embodiment, said conduits are provided grouped in a substantially cylindrical bundle, and wherein the apparatus further comprises one or more mechanisms for fanning out said conduits into one or more single row(s) of conduits before said sensor(s) are moved into position for measuring said one or more variables from each of said plurality of conduits.

In another embodiment, said apparatus comprises two said mechanisms for fanning out said conduits into two single rows of conduits, and wherein said apparatus comprises two sensors, each adapted to measure the conduits in one of the two single rows of conduits.

In another embodiment, said mechanism(s) for fanning out said conduits into one or more single row(s) comprises a clamp configured to clamp onto said conduits and force said conduits into position adjacent each other in a substantially linear row.

In another embodiment, said mechanism for fanning out said conduits into one or more single row(s) of conduits comprises a guiding structure along which said one or more sensor(s) is sequentially movable to individual conduits along said row for measuring said variable(s).

In another embodiment, said mechanism for fanning out said conduits into one or more single row(s) of conduits comprises a guiding structure along which said one or more sensor(s) is actuable to sequentially move to individual conduits along said row for measuring said variable(s).

In another aspect, the present invention broadly consists in a method of identifying a conduit from a plurality of similar conduits using the apparatus as described above.

In another aspect, the present invention broadly consists in an apparatus for identifying a conduit that is subjected to an internal pressure increase that is to be selected from a plurality of individually internally pressurisable conduits, each said conduit comprising a wall that is deformable upon increase in internal pressure, the apparatus comprising:
a compressor that is actuable to apply a radially compressive force to a said conduit to deform the conduit, the compressor being able to yield as the conduit moves back towards its un-deformed shape upon said increase in internal pressure of said conduit to be identified,
a sensor measuring the yield of the compressor to thereby identify the conduit that is subjected to said internal pressure increase.

In another embodiment the conduit identified is able, after identification, to be selected for subsequent processing.

In another embodiment identification is by way of visual sighting of indications on the unit, or a like device remote from the unit, to be seen by said user.

In another embodiment identification includes an audible response being provided by the apparatus or triggered by the apparatus.

In another aspect, the present invention broadly consists in a method for identifying a conduit (preferably to be selected from a plurality of individually internally pressurisable conduits) the or each said conduit comprising a wall that is deformable upon increase in internal pressure, the method comprising:
subjecting said conduit to be identified to an increase in internal pressure,
actuating a compressor to sequentially apply a radially compressive force to said plurality of conduits to deform the conduit,
detecting yielding of said compressor when said compressor is applied to said conduit subjected to said increase in internal pressure, as said conduit moves back towards its un-deformed shape, to thereby allow identification of said conduit.

In another aspect, the present invention broadly consists in a method of identifying a conduit (preferably to be selected from a plurality of conduits) the or each said conduit having a flexible wall, and said conduit to be identified comprising at least one open end, the method comprising:
applying a gas pressure signal at said open end of said conduit to be identified, to cause said conduit to be subjected to an increase in internal gas pressure,
sequentially measuring the plurality of conduits, at a position remote from said open end, at least one of the following variables:

a) width of the conduit,

b) diameter of the conduit,

c) temperature of the conduit wall,

d) load on the conduit wall, and

e) strain on the conduit wall,
wherein said conduit is identified upon detecting a change or changes in said variable(s) in response to said gas pressure signal.

In another embodiment the change is detected in the conduit to be identified.

Alternatively, preferably the change is detected in the other of the conduct(s), thereby allowing the conduit to be identified.

In another embodiment, said conduit is to be identified individually from a plurality of conduits, the plurality of conduits separate to each other or at least partially sheathed together.

In another embodiment, the method identifies a group of conduits comprising at least one conduit to be further identified.

In another embodiment, the method comprises the step of sequentially moving to individual conduits or groups of conduits for measuring said variable(s).

In another embodiment, the at least one sensor is actuated to be sequentially moved to individual conduits for measuring said variable(s).

In another aspect, the present invention consist in an apparatus for identifying a conduit having a flexible wall and an open end where a pressure signal is able to be applied to cause said conduit to be subjected to an increase in internal gas pressure, the apparatus comprising:
a jaw configured to accept at least a portion of the periphery of said conduit,
at least one sensor for measuring, at a measuring location remote from said open end, at least one of the width of the conduit, and the diameter of the conduit,
   wherein said conduit is identified when said sensor(s) detect(s) a change or changes in said width or diameter of said conduit so identified in response to said gas pressure signal.

In another embodiment, the sensor is a strain gauge.

In another embodiment, the strain gauge senses displacement due to an increase in diameter or width of said conduit in response to the pressure signal, of at least a portion of the jaws.

In another embodiment, the strain gauge can output an output voltage.

In another embodiment, the output voltage is sent to a processor or circuit to determine a positive or negative reading indicative of a pressurised conduit being identified or not.

In another embodiment, the processor or circuit is located remote from the apparatus or on the apparatus, and the positive reading or negative reading is indicated on the apparatus or remote from the apparatus via a visual or audible indication.

In another aspect, the present invention consists in an apparatus for identifying a conduit having a flexible wall and an open end where a pressure signal is applied to cause said conduit to be subjected to an increase in internal gas pressure, the apparatus comprising:

a jaw configured to accept at least a portion of the periphery of said conduit,

at least one sensor for measuring, at a measuring location remote from said open end, at least one of the following variables:

a) width of the conduit,

b) diameter of the conduit,

c) temperature of the conduit wall,

d) load on the conduit wall, and

e) strain on the conduit wall,
wherein said conduit is identified when said sensor(s) detect(s) a change or changes in said variable(s) experienced by said conduit so identified in response to said gas pressure signal.

The term “conduit” as used in this specification and claims means any duct, microduct, tube, pipe, etc., which has a flexible (i.e., non-rigid) wall. The conduit may be cylindrical, i.e., has a circular cross-section, or may have any other cross-sectional shape, as long as it is complete (i.e., the conduit is not an open channel).

The term “flexible” as used in this specification and claims when referring to wall(s) of the conduit means substantially non-rigid and deformable upon application of a force, e.g., such that at least a portion of the wall(s) may undergo some deformation when subjected to an internal pressure of about 1000 kPa, preferably under 1500 kPa.

The term “resiliently deformable” as used in this specification and claims when referring to wall(s) of the conduit means substantially deformable upon application of a force and able to return back (whether instantaneously or after a recovery period) into the previous/undeformed shape and/or dimension after the force has been removed, with minimal or no plastic/permanent deformation, e.g., does not undergo plastic deformation upon compression load of approximately 5 kg.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples only.

### BRIEF DESCRIPTION OF THE DRAWINGS

Preferred embodiments of the invention will be described by way of example only and with reference to the drawings, in which:

FIG. 1a shows components of the apparatus for identifying a conduit from a plurality of similar conduits according to one embodiment,

FIG. 1b shows a schematic side cross-sectional view of the embodiment of FIG. 1a,

FIG. 2 shows components of an apparatus for identifying a conduit from a plurality of similar conduits according to another embodiment,

FIGS. 3a to 3e illustrate the sequence of operation for dividing and fanning out a bundle of conduits according to one embodiment,

FIG. 4 schematically illustrates the pressure signal generator of the present apparatus according to one embodiment,

FIG. 5 schematically illustrates the pressure signal generator of the present apparatus according to another embodiment,

FIG. 6 shows an exemplary recorded graph of displacement and load in response to an input pressure signal,

FIG. 7 schematically illustrates another embodiment of the mechanism for separating a bundle of conduits into substantially linear arrays,

FIG. 8 shows components of an apparatus for identifying a conduit from a plurality of similar conduits according to another embodiment.

FIG. 9A shows a side view of a handheld apparatus.

FIG. 9B shows an end view of a handheld apparatus.

FIG. 9C shows a perspective view of the handheld apparatus separated into 2 halves.

FIG. 9D shows a photo of a front perspective view of a prototype handheld apparatus.

### DETAILED DESCRIPTION OF PREFERRED EMBODIMENTS

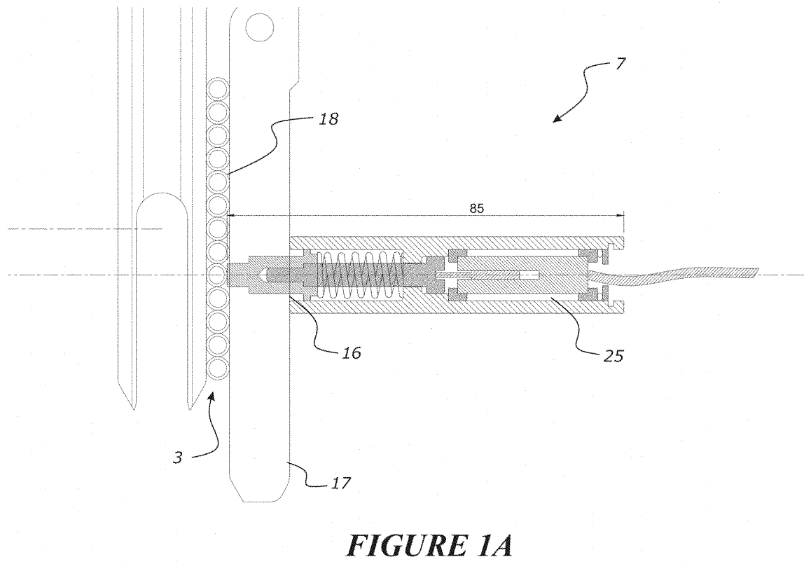

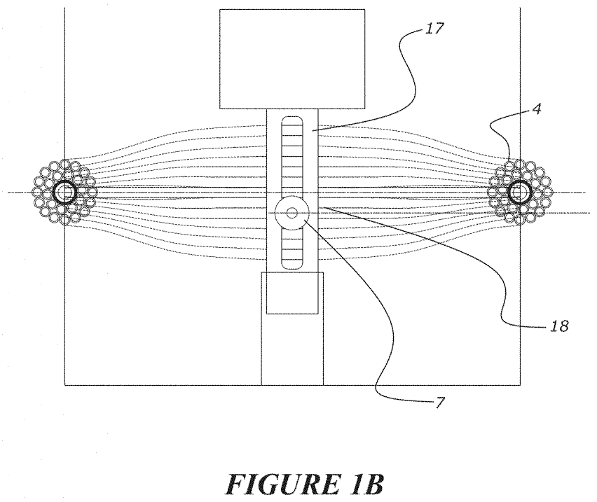

FIG. 1a shows components of one embodiment of an apparatus for identifying and selecting a conduit from a plurality of similar conduits 3. As illustrated, the conduits 3 may be provided or installed in a bundle 4.

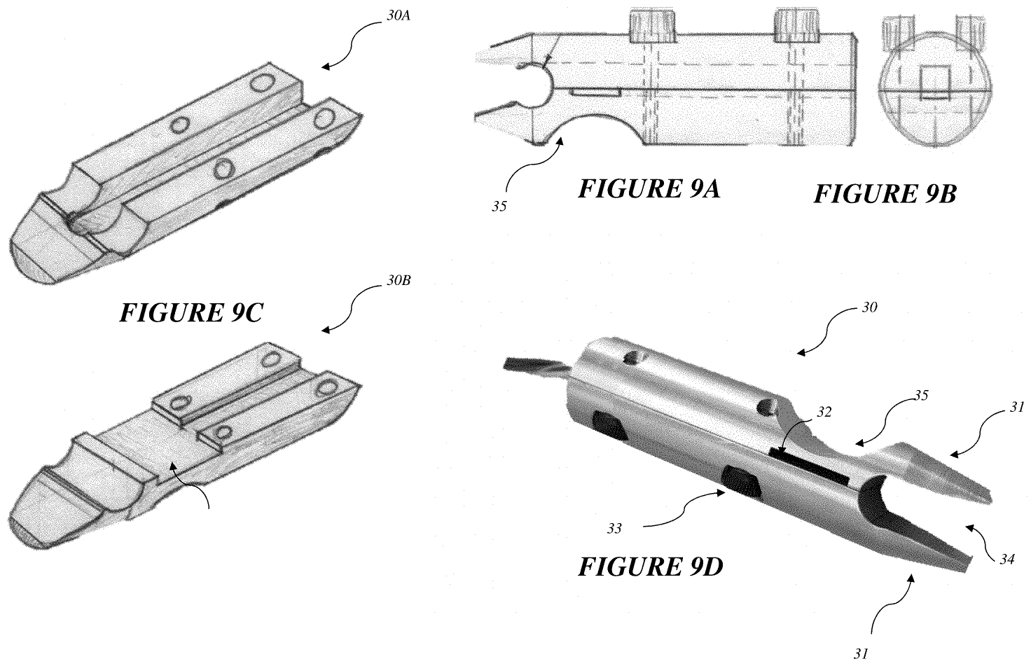

FIG. 9 shows a further embodiment of the current invention where the apparatus is a hand held apparatus 30 configured to identify a preselected (e.g. gas pressurized or similar) conduit 3. The conduits 3, may be provided in a bundle 4 or be presented as individual conduits. Where in the following description plural conduits are described, this may also describe instances where only one conduit is available, or where there are multiple conduits not in a bundle.

In some cases, most of the length of the conduits 3 may be substantially concealed or less visible to the installer or technician needing to see and/or work on the conduit. For example, the conduits may be within a building structure such as a wall, or under a floor, and may only be accessible via an aperture in the structure.

In another example, the conduits 3 may be a network of hollow/unfilled ducts or microducts buried underground, e.g., along a length of a street, in preparation for future fiber optic connection. During this subsequent installation of fiber optic cables into the microducts, the correct microduct must be selected, to then be cut and joined to another duct leading from/to the intended destination.

A trench or hole is dug in the ground to access a small section of the microducts. Conventionally, the microducts are colour coded to help the installer identify the correct microduct. Typically, this will involve the installer entering into the trench with a torch, to manually fan out the bundled microducts, then sort through it to identify the correctly coloured microduct.

The present methods and apparatus allow for identification of a conduit from a group of similar conduits without relying on visual examination of the conduits by the direct sight by a user. Accordingly, the present methods and apparatus allow for identification of conduits which are substantially concealed or less visible to the technician. The present methods and apparatus may also be used to identify a particular conduit from a group of visible but substantially visibly and/or shape-wise and/or dimensionally identical conduits.

In other instances, the conduits are separate from each other and are not in a bundle, or have been at least partially exposed from a sheath. Or there may only be one conduit in the vicinity of the apparatus. In these instances the handheld apparatus 30 or individual conduit identifying method may be used. In this case, the conduit is preselected by the present methods, and is identified by the apparatus.

In one particular example, the conduit may be a microduct configured to house and deploy fiber optic cables, e.g., for fiber to the x (FTTX) installations. For conciseness, the following description may refer to the conduits as microducts; however, it should be understood that the present methods and apparatus may be used to identify other types of flexible or semi-flexible and/or resiliently deformable conduits from a plurality of similar or substantially identical conduits.

At least the conduit to be identified and selected is open at one end, or able to be reversibly opened/unsealed at one end. The conduit is flexible, and preferably resiliently deformable, such that at least a part of the conduit is deformable (preferably, substantially reversibly) in the radial direction when subjected to an increase in internal pressure.

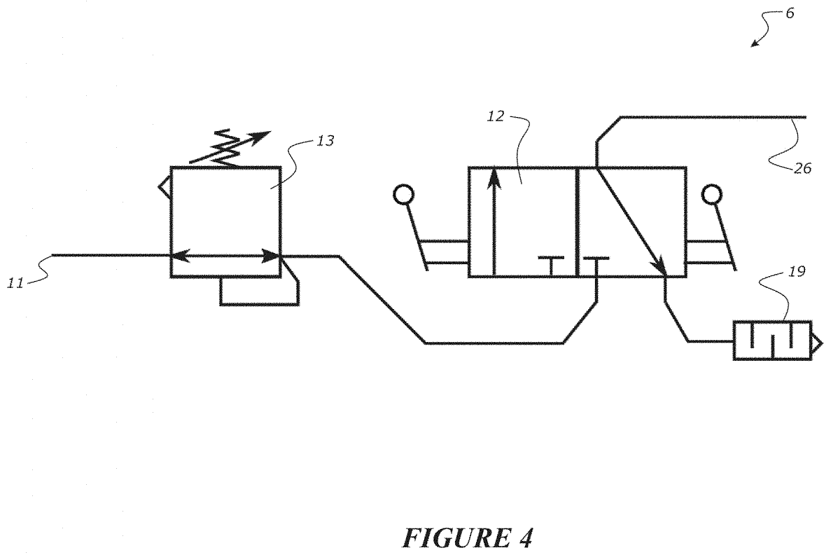

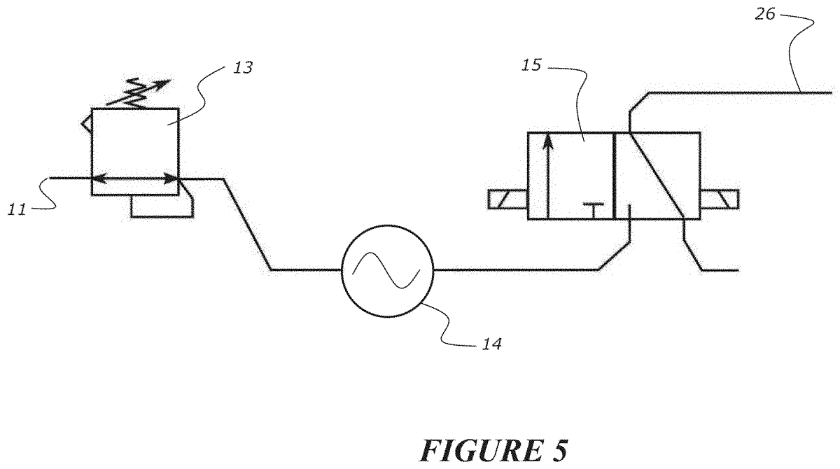

The conduit identifying apparatus further comprises a pressure signal generator 6 (for example, as illustrated in FIGS. 4 and 5) for applying a pressure signal at the open end of the conduit to be identified and selected, such that that conduit is subjected to an increase in internal pressure. The apparatus also comprises one or more sensors or a sensor assembly 7 (for example, as illustrated in FIGS. 1, 2, and 8) for measuring one or more of variables that change(s) in response to the increase in internal pressure.

For example, the variable measured could include a measurement of the conduit, such as width (and/or change in width) of the conduit (for conduits with non-circular cross-sections), or radius or diameter (and/or change in radius or diameter) of the conduit (for conduits with circular cross-sections), to detect deformation of the wall of the conduit, in response to the increase in internal pressure.

Alternatively, the variable measured could include forces or load on the conduit wall, and/or strain on the conduit wall.

Alternatively, the variable tracked could include temperature of the conduit. The increase in internal pressure increases the temperature of the conduit wall, due to deformation of the conduit wall and compression of gas within the conduit.

The variable(s) should be measureable externally of the conduit, as there will likely to be no access to the internal region of the conduit at the measurement site. It is envisaged that either contacting and contactless sensors may be used, provided that any contact does not significantly affect the variable being measured, or cause any significant permanent deformation of the conduit that could affect performance of the conduit.

The apparatus preferably further comprises one or more actuator(s) for sequentially moving the sensor(s) or sensor assembly 7 into position for measuring the variable(s) from each of the plurality of conduits 3. That is, the actuator preferably moves the sensor(s) or sensor assembly 7 sequentially along the array of conduits 3, positioning the sensor(s) 7 at or adjacent each conduit to sequentially measure each conduit.

Any suitable actuation mechanism may be used, for example, the sensor 7 may be guided on rails (or other guiding structures), and a motor (e.g., stepper or servo motor) may control step-wise movement of the sensor along the array of conduits 3. For example, as shown in FIG. 1b, the sensor 7 may be moved or guided along a guiding slot/structure defined by clamp 17 (that is configured to fan out the conduits into a linear row, as will be discussed in more detail below).

In other embodiments, the sensor 7 may be manually moved/positioned by the installer as required.

The conduit to be identified and selected is correctly identified when the sensor(s) or sensor assembly 7 detect(s) a change or changes in the variable(s) experienced by that conduit in response to the pressure signal. That is, the sensor(s) 7 is actuated to scan across the different conduits 3, measuring the variable(s) to identify which conduit experiences a change or changes in that variable as caused by the pressure signal.

The apparatus may further comprise a controller for automated or semi-automated control of the operation of sensor(s) 7 and/or actuator.

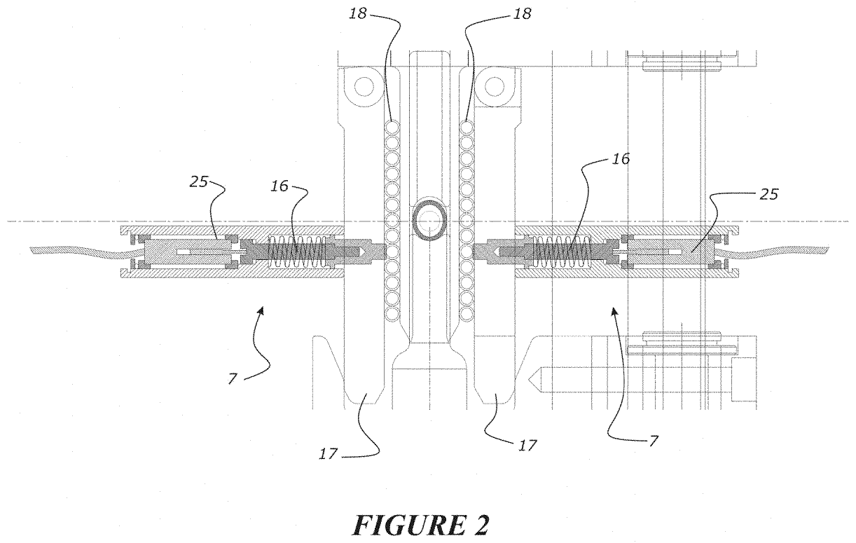

It will be appreciated that more than one sensor(s) or sensor assembly 7 may be provided and configured to simultaneously scan across different apportioned groups of the conduits 3, to speed up operation of the apparatus. For example, as shown in FIG. 2, the bundle 4 of conduits may be divided (manually or automatically) in half. The apparatus may comprise two sensors 7, each of which is configured to scan one half of the bundle of conduits, hence speeding up the conduit identification and selection process.

In another embodiment, an array of multiple sensors may be provided, each sensor configured to measure an individual conduit. For this embodiment, it may not be necessary to actuate the sensors (i.e., sensors need not be moved sequentially across the different conduits during the scanning phase), since each sensor is “assigned” to a single conduit, hence the sensing of all conduits may be done simultaneously.

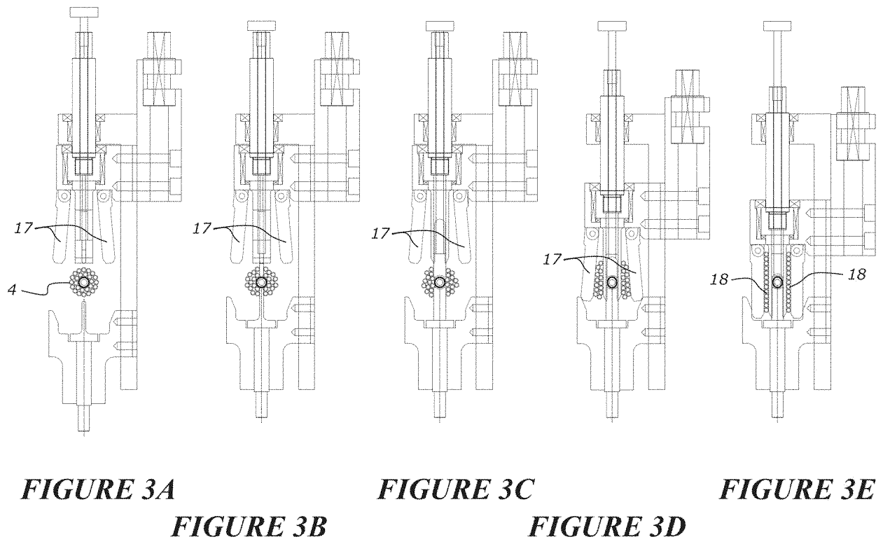

In some embodiments, for example as shown in FIGS. 1b and 3a-3e, where the conduits are provided as cylindrical bundles 4, the apparatus may comprise means for fanning out or spacing out the bundle of conduits 3 into one or more single rows 18 prior to the measuring/scanning step. The row 18 that is formed may be substantially linear (as shown in the drawings), but may also be curved, etc., provided the row comprises a single row of conduits (i.e., only one conduit along the width of the row).

For example, one or more elongate clamps 17 could be actuated (manually or automatically) to clamp onto the bundle 4 or part of the bundle, forcing the conduits into position adjacent each other, in a substantially linear row 18 within the clamp 17.

This may help to ensure that the sensor(s) 7 is/are moved linearly and sequentially past each conduit without missing any (at least until the conduit has been correctly identified). Spacing out the conduits may also help to ensure that the sensor detects the correct conduit especially in the case of small diameter conduits, and reduces interference between conduits.

In one embodiment, the apparatus is able to sense whether a pre-selected (i.e. pressurised or likewise) conduit is present within a group of conduits. The apparatus or user then able to determine if the pre-selected conduit 3 is in the current sensed group or in another group. The apparatus or user can then identify the pre-selected conduit 3 by process of elimination.

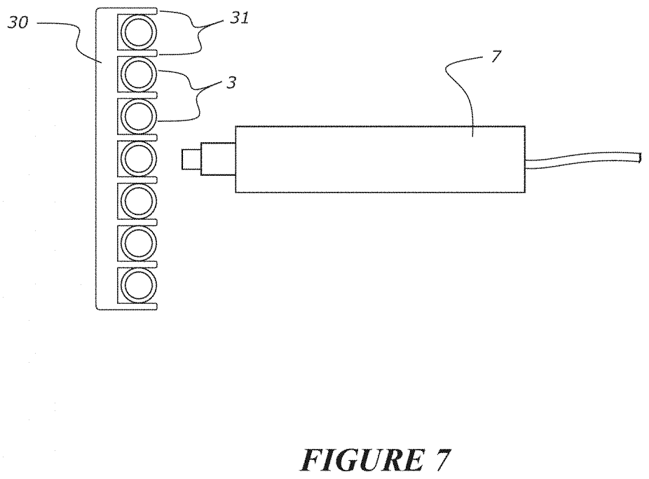

In another example as shown in FIG. 7, a comb-like mechanism 30 with spaced-apart teeth 31 could be provided to separate and space out the conduits 3 (e.g., one conduit in each space between two adjacent teeth) before the sensor 7 is actuated to perform the scanning/measuring operation. In some embodiments, a plurality of sensors may be provided, e.g., one at or adjacent each space between two teeth of the comb. In this case, each sensor may be configured to measure a single conduit, as discussed above.

In some embodiments, once the correct conduit has been identified, the apparatus (e.g., a controller of the apparatus) generates one or more signals, such as an audible, visual, haptic signal indicating that the conduit has been found.

Additionally or alternatively, once the correct conduit has been identified, the actuator may be stopped or suspended. In some embodiments, the controller receives feedback at this stage that the conduit has been identified, and accordingly stops the operation of the actuator, hence stopping the movement of the sensor(s) across the array of conduits 3.

In some embodiments, the apparatus may comprise a gripping or clamping assembly configured to reversibly hold on to the identified conduit, to allow for further operations on the conduit after it has been identified.

In the hand-held embodiment 30, the apparatus is pushed onto, or adjacent to, a conduit 3 by the user. To then identify or sense a further conduit 3, the handheld apparatus 30 is removed from one conduit 3 and moved to a different conduit 3, or to a different group of conduits as described herein.

If the apparatus is being used to sense groups (not shown), the apparatus is moved adjacent a group of conduits 3, and a reading taken. If a negative reading is taken, the handheld apparatus 30 may then be moved to a subsequent group and so forth until a positive reading is taken. The group can then be reduced in size, readings taken, and by process of elimination, the preselected conduit identified.

The clamping assembly may be integrally or separately formed from the sensor 7. Further, movement of the clamping assembly may be simultaneously or independently controlled by actuators (which may or may not be the same actuators controlling the movement of sensor 7).

In some embodiments, the clamping assembly moves in synchronisation with the sensor(s) or sensor assembly 7 across the array of conduits 3 during the scanning phase. For example, the clamping assembly may be integrally formed with the sensor 7 in an instrumented clip 20 as described in more detail below.

In other embodiments, the clamping assembly may be moved/actuated separately from the sensors 7, and may be actuated to grip the relevant conduit only after the conduit has been identified.

In other embodiments, the apparatus comprises a marker or other component that marks or leaves an identification device on the identified conduit. For example, the marker may print, stamp or adhere a visible (or otherwise machine identifiable, e.g., via RFID) mark onto the conduit, for future identification of the conduit.

In some embodiments, the position that the sensor(s) 7 is moved into for measuring the variable(s) is on or adjacent a conduit, at any point along the length of the conduit, remote from the open end of the conduit. For example, where the apparatus is used to detect a microduct from a bundle of microducts, the length of the microduct from origin (i.e., distribution point) to end user is typically about 500 m, but could be over 1 km. Accordingly, the present methods and apparatus are preferably configured to work with the sensor(s) 7 positioned at any point along the length of the microduct, and up to approximately 500 m (or over 1 km if required) away from the open end of the conduit (i.e., up to 500 m from where the pressure signal generator 6 inputs the pressure signal into the conduit to be identified).

In preferred embodiments, the pressure signal generator 6 comprises a source of compressed gas 11 and a valve for controlling output of compressed air, to generate the pressure signal. The source of compressed gas 11 may be a gas cylinder, diving tank, etc. Alternatively, the pressure signal generator 6 may comprise means for generating compressed gas, e.g. a compressor for pressuring a gas. Preferably the pressurised gas is dry.

In one embodiment, the temperature of the gas is controlled or known. This temperature variable can then be used as another or additional means to identify the conduit, or further used in processing data to identify conduits, or calibrate equipment.

In some embodiments, the pressure signal comprises a constant flow of compressed air (i.e., the pressure signal has a constant amplitude).

In other embodiments, the pressure signal comprises changes in the pressure amplitude. This may be generated using apparatus operating as per the schematic diagram of FIG. 4. The pressure input may be manually controlled via valve 12, with a regulator 13 to set a limit on the maximum pressure. The resulting pressure signal is input into the conduit at outlet 26. For the microduct example, the maximum pressure may be approximately 1000 kPa, more preferably about 700 kPa. Silencer 19 prevents excessive accumulation of pressure at a safety relief valve of manual valve 12.

In other embodiments, the pressure signal may comprise regular, periodic changes or pulses in pressure, using automatic valves 15 driven by a signal generator 14, as illustrated in FIG. 5. For example, valve 15 may be an electromechanical valve actuated by an electric motor or a solenoid, in response to input from signal generator 14.

In embodiments where there is a pressure signal that comprises changes in amplitude, the apparatus comprises a feature that allows the pressurised gas to be released from the conduit during periods between high-pressure pulses or similar. Such a feature can be a regulator or switched valve as part of the compressor, or for example a dive tank, which is open to atmosphere, or another containment region, during a particular period to release pressurised gas from the conduit.

In one embodiment, there is a vacuum applied to the conduit. This vacuum may only be a partial vacuum and may be applied in-between gas pulses to draw out some or much of the gas out of a conduit, or merely to increase the difference between the pressurised diameter of the conduit and the depressurised diameter of the conduit.

The vacuum in some embodiments is used solely without any positive gas pressure to be used instead of a positive gas pressure. Care must be taken that when a vacuum is used, it is used appropriately so as to not damage the micro conduit.

In some embodiments, the pressure signal may comprise low frequency pressure changes of between ambient pressure and the maximum pressure amplitude. For example, the frequency may be between 0.05 Hz to 5 Hz. In some preferred embodiments, the frequency is approximately 0.1 Hz.

Due to the small frequencies and voltages that are being measured or utilised, small temperature fluctuations or differences in the atmosphere; the conduit, the sensor, or tool may affect the measured variable readings. For this reason, in at least one embodiment the apparatus comprises heat insulation and/or is constructed from low heat conductive materials.

Gas inserted into the conduits may be cooled or heated to a temperature that aids in measuring the variables.

In further embodiments the apparatus comprises insulated regions to protect/isolate the sensor, or features related to the sensor, such as the features used to determine movement (such as the forks 31 or strain gauge described later). Heat can come from the user, atmosphere, or nearby equipment.

The maximum pressure amplitude applied is preferably selected to suit the conduit being identified. For example, the ideal pressure amplitude may be dependent on the material properties and/or size of the conduit, and/or the distance between the pressure signal input and the sensing location.

Preferably, the amplitude of the pressure signal is configured to cause a substantially reversible change in the variable to be measured. For example, the pressure is preferably not so high as to cause any permanent plastic deformation of the conduit that could affect the performance of the conduit.

In one example, the conduit/s are microducts which are typically manufactured from high-density polyethylene (HDPE), with diameters of between 3.5 and 14 mm. Typical wall thicknesses range from approximately 0.5 mm to 2 mm. For example, a typical thin wall microduct may have an inner diameter of about 3.5 mm and an outer diameter of about 5 mm. A typical thicker wall microduct may have an inner diameter of about 3.5 mm and an outer diameter of about 7 mm. For this application, the maximum amplitude of the pressure signal may be between 200 and 1500 kPa. In more preferred embodiments, the pressure signal may be configured to vary between 0 and 700 kPa, at a frequency of approximately 0.1 Hz. It will be appreciated that the characteristics of the pressure signal may be varied and tuned to suit the type of conduit being identified.

In some embodiments, during the scanning phase, the actuator retains the sensor(s) 7 in the measuring position at or adjacent each conduit 3 for a duration of between 1 second and 60 seconds. This duration is preferably selected to suit the frequency of the pressure signal being applied.

For example, where the pressure signal varies at a frequency of about 0.1 Hz, the sensor(s) 7 may be configured to remain at each conduit 3 for at least 10, more preferably about 15 to 20 seconds during the scanning phase. This would allow the sensor(s) 7 to remain at each conduit for a sufficient amount of time to be able to detect, in the conduit being injected with the pressure signal, the change in the variable(s) resulting from at least one full cycle of variation in the pressure signal.

Particular examples of sensor(s) 7 for measuring the variable(s) as listed above will now be described in more detail.

The input pressure signal may be configured to cause displacement of the wall of the conduit, detected as a change in a measurement (i.e., displacement) of the conduit, e.g., the radius or diameter, or a width dimension of the conduit (in the case of conduits with non-circular cross-sections). This change in measurement may accordingly be detected using one or more of linear variable differential transformers (LVDT), displacement sensors such as optical, ultrasonic or capacitive displacement sensors, and micrometers such as optical micrometers.

For example, FIGS. 1a, 2 and 8 show one or more sensors 7 comprising an LVDT 25. The LVDT is mechanically coupled to the conduit, e.g., via biasing mechanism 16, such that a change in the dimension (i.e., expansion) of the conduit is detectable by the LVDT 25.

In one embodiment, the apparatus measures the displacement of the wall of the conduit via a strain gauge. In particular the unit may measure the increase in diameter of the conduit via a strain gauge. The strain gauge provides an output, typically in the order of tens of Micro volts.

It is anticipated the output is greater than 0 microvolts, and no more than 500 microvolts but could be up to 1 millivolt. The range given is an example where the conduit is a micro conduit, and in particular a micro conduit that has an 8 mm outer diameter with a 2 mm wall thickness. In other embodiments where there is a smaller wall thickness, for example a half millimetre wall thickness, there will be a greater output of voltage due to greater displacement of the wall and hence strain gauge. In embodiments where the apparatus is not measuring a micro conduit, but measuring other types of conduit that have a far greater displacement, there will be a greater voltage output.

A handheld unit 30 of the apparatus is shown in FIGS. 9A-D. The unit 30 comprises forks 31 which form a jaw 34 which extend around a conduit 3 in operation. The displacement of the forks 31 is able to be read by a strain gauge (not shown) located in a slot or housing 32. Upon expansion of said conduit, one or more of the forks 31 are displace from their stable position. As the forks 31 are pushed apart, they affect a reading on the strain gauge 32. The strain gauge 32, in turn, outputs a voltage that is sent to be processed.

The output voltage may processed entirely within the handheld unit 30, or may be sent to a processor such as a laptop or similar. Once processed, the handheld unit 30, or the laptop or similar is able to display a positive or negative reading of the strain gauge 32. In one embodiment, the handheld unit 30 may comprise visual indication such as a screen, indicia, or lights to indicate to a user that a positive or negative reading has been taken.

In one embodiment the handheld unit 30 comprises a region of engineered weakness, or elastic stiffness. The region 35 is either geometrically more elastic, or materially more elastic. The region acts as a living hinge to allow displacement between forks or jaw, or from a fork which is adjacent a conduit. In the embodiment as shown in FIG. 9, the region is a curved or scalloped region. This curved region assists in improving the detection of the small movements required for identification. A person skilled in the art will realise there are many different ways of configuring a set of jaws or forks to act about a conduit, so that displacement of at least a portion of the jaws or forks is able to be measured by a strain gauge.

In one embodiment, the handheld version is formed of two parts, a top part 30A and bottom part 30B. These two parts are connected, in one embodiment, by threaded fasteners 33 to form the handheld unit 30. In other embodiments, the handheld unit 30 is integrally formed in one piece. There are many ways a person skilled in the art will be able to create a rigid, reliable handheld unit that is able to provide a set of forks or jaws that are materially stable. In a preferred embodiment, the handheld unit is composed of aluminium. In other embodiments, the handheld unit is composed of a composite material, or plastic.

The handheld unit may have an insulating feature between the handle and the working end of the unit—i.e. the strain gauge and fork, as described previously.

Additionally or alternatively, the input pressure signal may be configured to cause a change in the load on the wall of the conduit. This change in load may accordingly be detected using one or more of load cells, or other types of force sensors such as piezoelectric force sensors.

Additionally or alternatively, the input pressure signal may be configured to cause a strain or change in the strain on the wall of the conduit. This change in strain may accordingly be detected using strain gauges.

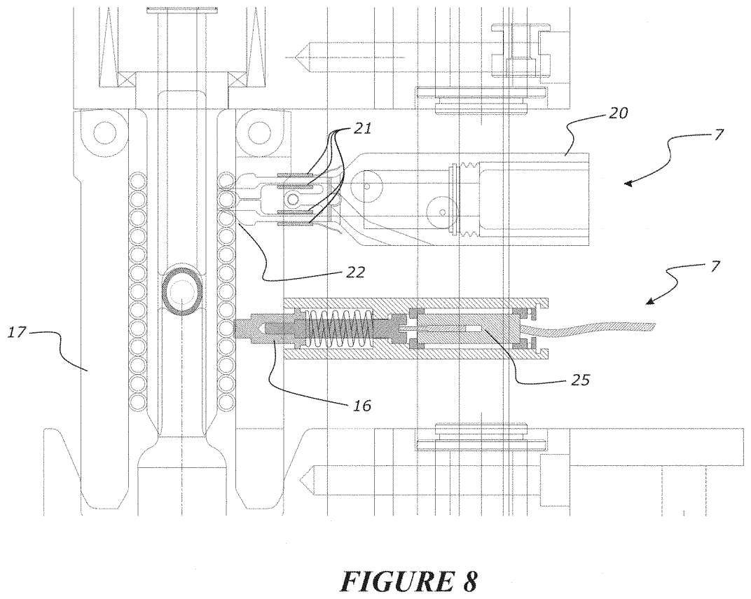

For example, FIG. 8 shows one embodiment of a sensor 7 comprising an instrumented clip 20 and strain gauges 21. The clip applies a compressive preload via clip jaws 22 onto the conduit, to deform the conduit (in one example, the clip 20 may initially deform the outer diameter of the conduit from 5 mm to 4.5 mm). When the pressure signal is subsequently input into the conduit to be identified, the conduit will expand and the clip jaws 22 will yield in response to this expansion of the conduit back towards its undeformed shape. This yielding is detected and/or measured by the strain gauges 21 of the clip jaws 22 in the correct conduit to be identified.

This embodiment has the advantage that the clip 20 integrally comprises both the sensor(s) 7 and a compressor for applying a compressive preload to the conduit (via clip jaws 22). Accordingly, the actuation mechanism for moving the sensor(s) and the preloading mechanism may be simplified.

It should be noted that while the embodiment of FIG. 8 shows two sensor assemblies (sensing both strain via strain gauges 21, and displacement via LVDT 25), in other embodiments, only one sensor, or one type of sensor, may be provided.

It should additionally be noted that the sensor(s) 7 could be configured to measure a change in the variable(s) directly from the conduit, or indirectly, e.g., by detecting a yielding/deformation of the compressor (e.g. clip jaws 22) engaged with the conduit, that is caused by and can be directly associated with, the change in variable in the conduit in response to the increase in internal pressure.

Where displacement, load and/or strain is/are detected by sensor(s) 7, the apparatus preferably comprises at least one compressor for applying a reversible and localised compressive preload onto the conduit at or near the site of measurement, to cause deformation of the conduit in the radial direction. This compression may be applied, for example, via biasing means 16, clip jaws 22 or other biasing spring arrangements. As a result, when the pressure signal is input and internal pressure increases, the conduit tends to expand back to its original shape/dimensions; this change in displacement, load and/or strain is accordingly measured by the sensor(s) 7. Without the compressive preload, it has been found that any change in displacement, load and/or strain in an unloaded conduit may not be detectable, depending on material properties of the conduit. Measuring the change at the localised, compressed site essentially amplifies the change detected.

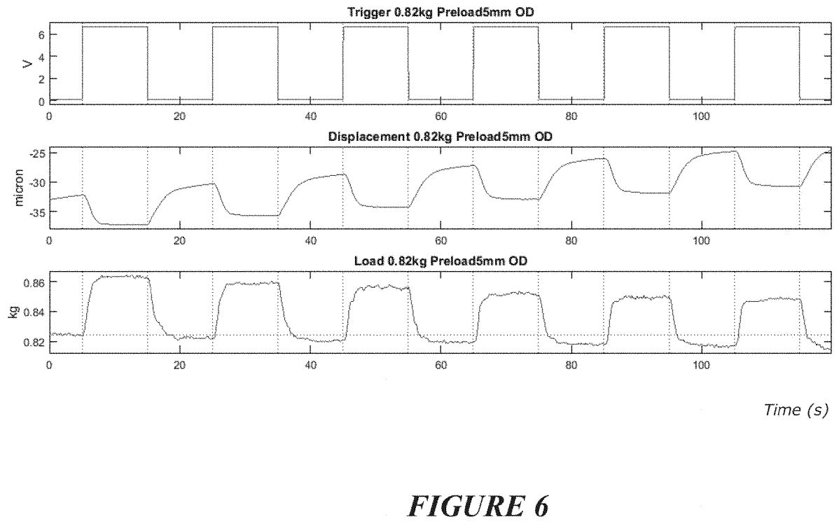

FIG. 6 shows exemplary recorded data of displacement and load, as measured on a conduit of 5 mm outer diameter, approximately 110 m away from the open end 5 where the pressure signal is input. A compressive preload of 0.82 kg was applied at the measurement site. The data was recorded over six cycles of the pressure signal, varying between 0 and 7000 kPa, as triggered by a signal shown in the uppermost plot. Displacement (middle plot) was measured using an LVDT, and load (bottom plot) was measured using a load cell.

The amount of preload is selected to suit the particular conduit to be identified (e.g., depending on the material properties and/or thickness of the conduit wall) and further, to apply a substantially reversible load on the conduit. That is, the amount of preload is not so high as to cause any permanent plastic deformation of the conduit that could affect the performance of the conduit.

For example, where the conduit/s are microducts as described above, the compressive preload may be between 0.5 kg and 7 kg, depending on properties of the microduct such as the thickness of the wall of the microduct. In preferred embodiments, the preload is at least about 3 kg.

In additional or alternative embodiments, the input pressure signal may be configured to cause a change in the temperature of the conduit. Deformation of the conduit wall and/or compression of air or gas within the conduit may cause an increase in the temperature detectable at the conduit wall. This thermal effect may accordingly be detected using one or more of thermometers, thermocouples, thermal imaging cameras and infrared sensors.

Preferably, the conduit to be identified and selected has a sealed end, or is able to be reversibly sealed or substantially compressed at one point of the conduit. In such cases, the measuring location would be intermediate this sealed point and the open end of the conduit. This may be particularly important for embodiments where the variable measured is temperature, as the applicants have found that the thermal effect is most noticeable near a sealed point/end of the conduit.

In some embodiments, the conduit to be identified and selected and the plurality of similar conduits 3 may be empty and/or substantially hollow at least during the identification process and at least at the measurement location. That is, the conduits may not be electrically conductive and may not comprise electrical conductors.

In some embodiments, the conduit 3 may be filled (e.g., partially) with a fluid. For example, buried microduct bundles typically become filled with water/sludge while in the in-ground hole. Accordingly, the present apparatus and methods are configured to be able to work with non-conductive, substantially hollow conduits which may be filled with liquid.

Preferred methods for identifying and selecting a conduit from a plurality of similar conduits 3 will now be discussed in more detail.

A pressure signal is applied at the open end of the conduit to be identified and selected, such that the conduit is subjected to an increase in internal pressure. For each of the plurality of similar conduits 3, one or more variable(s) that would be affected by the increase in internal pressure is/are measured. The variable(s) may include: a width of the conduit, diameter or radius of the conduit, temperature of the conduit wall, forces/load on the conduit wall, and strain on the conduit wall. The conduit to be identified and selected is accordingly identified upon detecting a change or changes in the variable(s) in response to the pressure signal.

In preferred embodiments, the method of identifying the conduit employs one or more embodiments of the apparatus as described above. However, it will be appreciated that the method described may be accomplished via more manual means, or using any other suitable apparatus or systems.

In some embodiments, once the conduit is identified, the conduit is further processed, whether manually or automatically. In some cases, the apparatus may further comprise one or more components configured for this subsequent processing.

For example, the conduit identifying apparatus and methods may be used together with the conduit processing tool and methods described in co-pending application NZ 711895, herein incorporated by reference. In some embodiments, both the identification and processing apparatus may be integrally provided as a single system, e.g., with one control system controlling both the conduit identification and the conduit cutting processes. In some cases, the clamping assembly of the present apparatus that is configured to hold onto the conduit once identified and selected, may also be or comprise the conduit contacting member of co-pending application NZ 711895, that is provided to position and physically support at least a portion of the conduit (once identified) relative to the cutting tool.

In some embodiments, where the conduits 3 are microducts provided for FTTX installations, further processing after the conduit is identified may include installing a fiber optic cable into the identified conduit (e.g., via pushing, pulling or blowing the fiber optic cable as known in the art).

Providing means for identifying the correct microduct without requiring visual examination of the microduct bundle may allow for a reduction in the civil work required and/or an increase in efficiency, accuracy and cost-effectiveness of the microduct identifying process.

It is envisaged that the size of the conduit identifying apparatus may be configured such that a smaller trench is required at the measurement sites, compared to the size of the trenches conventionally required for full manual inspection of the microducts.

Further, it is envisaged that the present methods and apparatus will improve efficiency and reduce errors relating to conduit identification, compared to conventional manual inspection methods. Because of the direct association between pressure input and variable(s) measured, the method may be automated or semi-automated as described above, to reduce the risk of human error.

In some embodiments, the conduit identification method could be performed by a single worker. The worker could set the automated pressure signal generator (as described above) at the open end of the conduit to be identified, to continuously generate the signal, then proceed to the measurement site to measure the variable(s) and identify the correct conduit.

Other embodiments could involve two workers, one stationed at the open end of the conduit to operate the pressure signal generator, and the other at the measurement site.

In some embodiments, the present apparatus and methods may not perform the entire conduit identification and selection in an entirely automated process, but may instead be used to assist installers with conduit identification. In the case of microduct selection, for example, some microducts within the bundle may be coloured similar to others, while others may be uniquely coloured (e.g., in a 7-way bundle, there may be one white, one green, four blue and one red microduct). The installer may be able to manually identify the uniquely coloured microducts, but may require the present apparatus or methods to identify the correct blue microduct out of the four similarly coloured blue microducts, for example.

The foregoing description of the invention includes preferred forms thereof. Modifications may be made thereto without departing from the scope of the invention.

1. An apparatus or system for identifying a conduit, having a flexible wall, and comprising at least one open end, the apparatus or system comprising:
a gas pressure signal generator for applying a pressure signal at said open end of said conduit to be identified, to cause said conduit to be subjected to an increase in internal gas pressure,
at least one sensor for measuring, at a measuring location remote from said open end, at least one of the following variables:
a) width of the conduit,
b) diameter of the conduit,
c) temperature of the conduit wall,
d) load on the conduit wall, and
e) strain on the conduit wall,
wherein said conduit is identified when said sensor(s) detect(s) a change or changes in said variable(s) experienced by said conduit so identified in response to said gas pressure signal.

2. The apparatus or system as claimed in claim 1 wherein said conduit to be identified individually from a plurality of conduits, the plurality of conduits separate to each other or being at least partially sheathed together.

3. The apparatus or system as claimed in claim 1, wherein said apparatus or system is configured to identify a group of conduits comprising at least one conduit to be identified.

4. The apparatus or system as claimed in claim 1, wherein the at least one sensor is able to be sequentially moved to individual conduits or groups of conduits for measuring said variable(s).

5. The apparatus or system as claimed in claim 1, wherein the at least one sensor is actuable to be sequentially moved to individual conduits for measuring said variable(s).

6. The apparatus or system as claimed in claim 1, wherein an actuator is provided to sequentially move said sensor(s) to individual conduits for measuring said variable(s).

7. The apparatus or system of claim 6, further comprising a controller for automated control of said sensor(s) and/or said actuator, wherein said controller is configured to cause a signal to be generated once said conduit has been identified.

8. The apparatus or system of claim 6, further comprising a controller for automated control of said sensor(s) and/or said actuator, wherein said controller is configured to stop movement of said sensor to another conduit once said conduit has been identified.

9. The apparatus or system as claimed in claim 1, wherein said sensor is positioned on or adjacent a conduit when measuring said variable(s).

10. The apparatus or system as claimed in claim 1, wherein said gas pressure signal generator comprises or generates a source of compressed gas.

11. The apparatus or system of claim 10, wherein said gas pressure signal generator further comprises:
a signal generator, and
an outlet valve controlled by said signal generator,
wherein said gas pressure signal generator is configured to output pressure signals comprising low frequency changes in gas pressure.

12. The apparatus or system of claim 11, wherein said gas pressure changes at a frequency of between 0.05 Hz to 5 Hz.

13. (canceled)

14. The apparatus or system of as claimed in claim 6, wherein said actuator retains said sensor(s) at a said conduit for measuring said one or more variables for a duration of between 1 second and 60 seconds.

15. The apparatus or system as claimed in claim 14, wherein said sensor(s) is/are retained at a said conduit for a duration of approximately 20 seconds.

16. The apparatus or system as claimed in claim 1, wherein said conduit/s comprises a sealed end.

17. The apparatus or system as claimed in claim 1, wherein said conduit/s to be measured is sealed or caused to be sealed at a location such that said sensor measures said conduit intermediate of the open end and where the conduit is sealed.

18.-46. (canceled)

47. An apparatus or system for identifying a conduit that is subjected to an internal pressure increase, said conduit comprising a wall that is deformable upon increase in internal pressure, the apparatus or system comprising:
a compressor that is actuable to apply a radially compressive force to said conduit to deform the conduit, the compressor being able to yield as the conduit moves back towards its un-deformed shape upon said increase in internal pressure of said conduit to be identified,
a sensor measuring the yield of the compressor to thereby identify the selected conduit that is subjected to said internal pressure increase.

48. The apparatus or system as claimed in claim 47, wherein the conduit that is subjected to the internal pressure increase is to be identified and/or selected from a plurality of individually internally pressurisable conduits.

49. A method for identifying a conduit, said conduit comprising a wall that is deformable upon increase in internal pressure, the method comprising:
subjecting said conduit to be selected to an increase in internal pressure,
actuating a compressor to sequentially apply a radially compressive force to said plurality of conduits to deform the conduit,
detecting yielding of said compressor when said compressor is applied to said conduit subjected to said increase in internal pressure, as said conduit moves back towards its un-deformed shape, to thereby identify said conduit to be selected.

50. The method as claimed in claim 49, wherein the conduit that is subjected to the internal pressure increase is to be selected from a plurality of individually internally pressurisable conduits.

51.-61. (canceled)
